(19) United States
(12) Patent Application Publication
(10) Pub. No.: US 2023/0228487 A1
(43) Pub. Date: Jul. 20, 2023

(54) SYSTEM AND METHOD FOR DRYING USING HYDROGEN COMBUSTION EXHAUST

(71) Applicant: Ohmium International, Inc., Incline Village, NV (US)

(72) Inventors: Celeste Mueller, Incline Village, NV (US); Arne Ballantine, Incline Village, NV (US); Fred Freeland, Incline Village, NV (US); Chockkalingam Karuppaiah, Incline Village, NV (US)

(21) Appl. No.: 18/099,132

(22) Filed: Jan. 19, 2023

Related U.S. Application Data
(60) Provisional application No. 63/300,908, filed on Jan. 19, 2022.

(51) Int. Cl. F26B 23/02; F26B 21/00

(52) U.S. Cl. CPC F26B 23/02; F26B 21/003; F26B 2200/06; F26B 2200/20

(57) ABSTRACT

The present disclosure relates to systems and methods for drying materials using hydrogen combustion exhaust. The system generally includes a hydrogen generator, a burner, and a drying chamber. The method generally includes burning hydrogen and directing the combustion exhaust to a drying chamber, wherein the heat from the combustion exhaust dries the material.

### CROSS-REFERENCE TO RELATED APPLICATIONS

This application claims priority to U.S. Provisional Application No. 63/300,908 entitled “SYSTEM AND METHOD FOR DRYING USING HYDROGEN COMBUSTION EXHAUST”, filed Jan. 19, 2022, the entire contents of which are incorporated by reference herein.

### FIELD OF THE DISCLOSURE

The present disclosure relates to systems and methods for drying materials using hydrogen combustion exhaust. Accordingly, the disclosure is related to the fields of process engineering and chemical engineering.

### BACKGROUND

Historically, the coffee industry has utilized non-renewable fuel sources in the coffee drying process. These sources often include gas, oil, coal, or timber, leading to either significant carbon emissions or deforestation, both of which are harmful to the environment. Additionally, these processes rely on the transportation of fuel sources to the dryer location, which introduces reliability issues to the plant, as well as further increases harmful CO₂ emissions. Moreover, because the combustion gas from these sources contains harmful pollutants such as particulate matter, SOₓ, carbon monoxide, and CO₂, the combustion exhaust cannot directly contact the coffee beans in the dryer and a separate heat exchanger is required to dry the coffee beans.

What is needed is a system for drying materials that is less harmful to the environment.

### SUMMARY OF THE DISCLOSURE

Described herein is a system for drying a material by using hydrogen combustion exhaust. The system includes a hydrogen generator, a burner in fluid communication with the hydrogen generator, and a drying chamber in fluid communication with the burner operable to receive the material and combustion exhaust generated in the burner. The combustion exhaust directly contacts the material in the burner. In some embodiments, the material is an agricultural product and/or plant product; for example, in some aspects, the agricultural product is selected from the group consisting of coffee beans, cocoa, wheat, corn, barley, millet, sorghum, oats, rice, rye, legumes, chia, quinoa, buckwheat, mustard, rapeseed, sunflower seed, flax seed, poppy seed, tea, or a combination thereof. In some examples, the agricultural product comprises a grain, seed, legume, leaf, bean, or a combination thereof. In some examples, the agricultural product is coffee beans. In some embodiments, the hydrogen generator is an electrolyzer. In some examples, the hydrogen generator is a proton exchange member based electrolyzer. In some embodiments, the hydrogen generator is a steam methane reformer. In some embodiments, the hydrogen generator is located at the same site as the drying chamber. In some embodiments the burner is a catalytic combustion burner. In some aspects, the drying chamber is an industrial dryer. In some additional aspects, the drying chamber is an industrial oven. In some embodiments, the combustion exhaust consists essentially of water, hydrogen, oxygen, and nitrogen.

In some embodiments, the system further includes a first blower operable to provide an oxygen source to the burner. In some aspects, the oxygen source is air. In some additional aspects, the oxygen source is pure oxygen. In some embodiments, the system includes a second blower operable to provide cool air to the combustion exhaust. In some additional embodiments, the system includes a condenser in fluid communication with the drying chamber. In still additional embodiments, the system includes a renewable energy source. In some aspects, the renewable energy source includes photovoltaic, wind, hydroelectric, or hydrogen fuel cells.

Further provided herein is another system for drying a material by using hydrogen combustion exhaust. The system includes a hydrogen generator, a burner in fluid communication with the hydrogen generator, a heat exchanger in fluid communication with the burner and the drying chamber, and a drying chamber in fluid communication with the burner operable to receive the material and combustion exhaust generated in the burner. The combustion exhaust comprises and/or consists essentially of water, hydrogen, oxygen, and nitrogen. In some embodiments, the material is an agricultural product; for example, in some aspects the agricultural product is selected from the group consisting of coffee beans, cocoa, wheat, corn, barley, millet, sorghum, oats, rice, rye, legumes, chia, quinoa, buckwheat, mustard, rapeseed, sunflower seed, flax seed, poppy seed, and tea. In some examples, the agricultural product is coffee beans. In some embodiments, the hydrogen generator is an electrolyzer. In some examples, the hydrogen generator is a proton exchange member based electrolyzer. In some embodiments, the hydrogen generator is a steam methane reformer. In some embodiments, the hydrogen generator is located at the same site as the drying chamber. In some embodiments the burner is a catalytic combustion burner. In some aspects, the drying chamber is an industrial dryer. In some additional aspects, the drying chamber is an industrial oven.

In some embodiments, the system comprises a coolant loop operable to transfer heat produced by the hydrogen generator to the drying chamber. In some aspects, the heat may be transferred to the drying chamber via a heat exchanger. In some additional aspects, the coolant loop comprises a radiator.

In some embodiments, the system further includes a first blower operable to provide an oxygen source to the burner. In some aspects, the oxygen source is air. In some additional aspects, the oxygen source is pure oxygen. In some embodiments, the system includes a second blower operable to provide cool air to the combustion exhaust. In some additional embodiments, the system includes a condenser in fluid communication with the drying chamber. In still additional embodiments, the system includes a renewable energy source. In some aspects, the renewable energy source includes photovoltaic, wind, hydroelectric, or hydrogen fuel cells.

In some embodiments, the system comprises a coolant loop operable to transfer heat produced by the hydrogen generator to the drying chamber. In some aspects, the heat may be transferred to the drying chamber via a heat exchanger. In some additional aspects, the coolant loop comprises a radiator.

Further provided herein is another system for drying a material by using hydrogen combustion exhaust. The system comprises a hydrogen generator, a burner in fluid communication with the hydrogen generator, a heat exchanger in fluid communication with the burner and a drying chamber; a blower in fluid communication with the heat exchanger, operable to provide cool air to the heat exchanger; wherein the heat exchanger is operable to transfer heat from the combustion exhaust to the cool air, which is then provided to the drying chamber.

Further described herein is a method for drying a material using hydrogen combustion exhaust. The method includes burning hydrogen to create combustion exhaust and contacting the combustion exhaust with the material. In some embodiments, the material is an agricultural product; for example, in some aspects the agricultural product is selected from the group consisting of coffee beans, cocoa, wheat, corn, barley, millet, sorghum, oats, rice, rye, legumes, chia, quinoa, buckwheat, mustard, rapeseed, sunflower seed, flax seed, poppy seed, and tea. In some examples, the agricultural product is coffee beans. In some embodiments, the method further includes generating hydrogen. In some aspects, the hydrogen is generated using an electrolyzer. In some embodiments, the hydrogen is burned through catalytic combustion. In some embodiments, the method further includes cooling the combustion exhaust before contacting the combustion exhaust with the material. In some aspects, the combustion exhaust is cooled with air. In some embodiments, the method further includes generating oxygen. In some embodiments, the method further includes condensing the water in the combustion exhaust after contacting the combustion exhaust with the material. In some embodiments, the combustion exhaust comprises and/or consists essentially of hydrogen, oxygen, water, and nitrogen.

### BRIEF DESCRIPTION OF THE FIGURES

FIG. 1 shows a prior art system used for drying coffee beans.

FIG. 2 shows a system of the present disclosure for drying a material.

FIG. 3 shows an alternative embodiment of the system of the present disclosure for drying a material.

FIG. 4 shows an alternative embodiment of the system of the present disclosure for drying a material. The system includes a thermal loop.

FIG. 5 shows an alternative embodiment of the system of the present disclosure for drying a material. The system includes a plant for processing fertilizer.

### DETAILED DESCRIPTION

Described herein are systems and methods for drying materials using hydrogen combustion exhaust. By using hydrogen (e.g., hydrogen gas and/or H₂) as a fuel source as opposed to conventional fossil fuels, biomass, and other non-renewable fuel sources, the materials are not exposed to pollutants through direct contact with the combustion exhaust. Thus, the hydrogen combustion exhaust may contact the materials directly to dry the materials without the need for a heat exchanger. This decreases costs throughout the life of the facility and reduces overall greenhouse gas emissions produced from the process. Additionally, the hydrogen may be generated on-site by electrolysis powered by renewable energy sources, thereby obviating the need to transport fuel to the facility and providing additional cost savings and greenhouse gas reduction.

In some embodiments, the materials may be agricultural products. Agricultural products include any product generated through the practice of agriculture, including but not limited to coffee beans, cocoa, sugar cane, grains (e.g., wheat, corn, barley, millet, sorghum, oats, rice, rye, legumes, chia, quinoa, buckwheat, mustard, rapeseed, sunflower seed, flax seed, poppy seed, etc.), tea, or other agricultural products. In a non-limiting example, the agricultural products are coffee beans.

In some embodiments, the materials may include non-agricultural products, including concrete, paper, pulp, and plastics.

### I. System

Described herein are systems for drying materials using hydrogen combustion exhaust. Generally, the systems provided herein include a hydrogen generator, a burner, and a drying chamber. The hydrogen combustion exhaust may be mixed with air to control the temperature of the combustion exhaust prior to contacting the materials in the drying chamber. By using hydrogen as a fuel source for combustion, the air used in the drying chamber may be free of or substantially free of SOₓ, CO, CO₂, particulate matter, NOₓ (particularly when catalytic combustion is used to burn the hydrogen), and other pollutants. In some embodiments, the system may not use gas, oil, coal, biomass, timber, or a combination thereof as a fuel source. In some additional embodiments, the system may not use gas, oil, coal, biomass, timber, or a combination thereof as a fuel source for the burner. In still additional embodiments, the system may not use gas, oil, coal, biomass, timber, or a combination thereof as a fuel source for electricity.

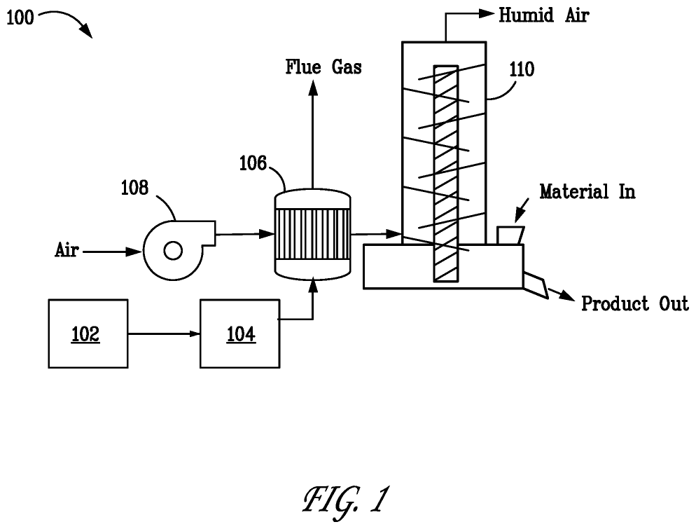

Referring now to FIG. 1, a prior art system 100 for drying materials includes a non-renewable fuel source 102, a burner 104, a heat exchanger 106, a blower 108, and a drying chamber 110. The combustion exhaust from the burner 104 contains harmful pollutants that cannot contaminate the materials, otherwise the materials will not be suitable for commercial use, e.g., consumption. Therefore, the combustion exhaust enters the heat exchanger 106 and is released into the atmosphere. This results in a loss of efficiency because the heat generated during the combustion process is not directly applied to the materials in the drying chamber; instead, it must be transferred to another medium via a heat exchanger. Additionally, this system results in the same harmful pollutants entering the atmosphere, which presents environmental challenges such that additional equipment may be required to prevent release of the pollutants into the atmosphere.

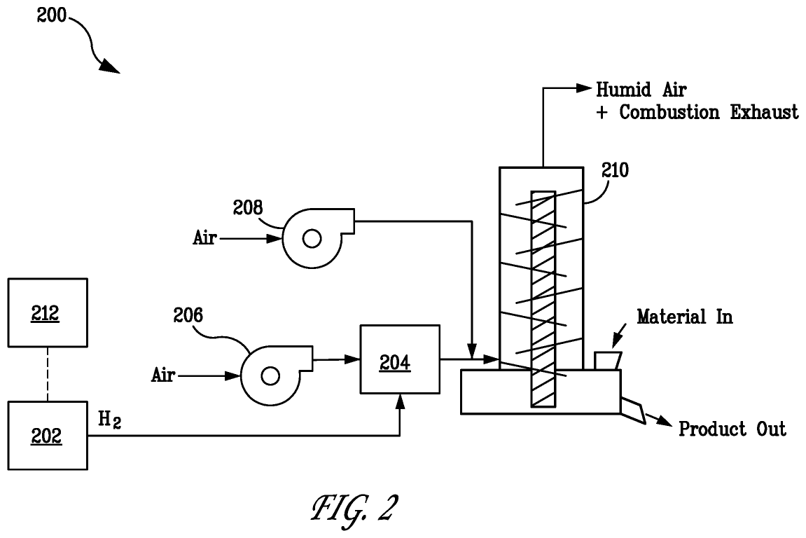

Referring now to FIG. 2, a system 200 of the present disclosure includes a hydrogen generator 202, a burner 204, a first blower 206, and a drying chamber 210. The hydrogen generator 202 is in fluid communication with the burner 204 to provide hydrogen to the burner. The first blower 206 is also in fluid communication with the burner 204. The first blower 206 provides air or oxygen to the burner 204 to create a suitable environment for combustion. The burner 204 is in fluid communication with the drying chamber 210. The combustion exhaust from the burner 204 enters the drying chamber 210 and dries the materials. The combustion exhaust contains essentially no pollutants. In some embodiments, a second blower 208 may be included to provide cool air to the combustion exhaust, thereby controlling the temperature of the combustion exhaust entering the drying chamber 210. In some embodiments, the system may include a renewable energy source 212 to provide electricity to the facility. In some aspects, the renewable energy source 212 may be located on-site, or it may be at another location. The renewable energy source 212 may be photovoltaic, wind, hydroelectric, or hydrogen fuel cells. In some embodiments, the renewable energy source 212 includes a hydrogen fuel cell. In an exemplary embodiment, the hydrogen fuel cell provides electricity for the entire system. The hydrogen produced in the hydrogen generator 202 may be used to fuel the hydrogen fuel cell; alternatively, the hydrogen for use in the hydrogen fuel cell may be provided from a different source. In some embodiments, such as the system of FIG. 2, the system may not include a heat exchanger coupled to the burner.

The hydrogen generator 202 is operable to produce hydrogen. Methods of producing hydrogen, such as electrolysis and steam methane reforming, are generally well-known in the art. In some embodiments, the hydrogen generator may be located off-site.

The hydrogen generator 202 may include an electrolyzer. In some aspects, the electrolyzer may be located on-site, thus providing an on-demand source of hydrogen that may be fed directly into the drying process. In an exemplary embodiment, the hydrogen generator is an electrolyzer that is located on-site and is powered through renewable energy sources, such as wind, solar, hydroelectric, geothermal, etc. In some additional aspects, the electrolyzer may be a proton exchange membrane (PEM)-based electrolyzer, an anion exchange membrane (AEM)-based electrolyzer, or an electrolyzer comprising both proton exchange membranes and anion exchange membranes. Exemplary electrolyzers suitable for use in the systems of the present disclosure are described in U.S. application Ser. No. 17/101,232 entitled “Electrochemical Devices, Modules, and Systems for Hydrogen Generation and Methods of Operating Thereof” field Nov. 23, 2020, the entire contents of which are incorporated by reference herein.

In other embodiments the hydrogen generator 202 may be a reformer-based generator, such as a steam methane reformer. Steam methane reformation is a well-known process for producing hydrogen. The process generally requires the use of high temperature steam (e.g., 700-1000° C.) to react with methane under about 3-25 bar of pressure in the presence of a catalyst. This also produces carbon monoxide gas, which may be further reacted with steam to produce carbon dioxide and additional hydrogen.

The hydrogen generator 202 may include a plurality of hydrogen generators 202 connected in parallel; for example, the hydrogen generator 202 may include a plurality of electrolyzers connected in parallel.

The mass flow rate of the hydrogen from the hydrogen generator 202 may be from about 1 kg/h to about 1000 kg/hr. In some aspects, the mass flow rate of hydrogen may be about 1 kg/h to about 100 kg/h, about 100 kg/h to about 200 kg/h, about 200 kg/h to about 300 kg/h, about 300 kg/h to about 400 kg/h, about 400 kg/h to about 500 kg/h, about 500 kg/h to about 600 kg/h, about 600 kg/h to about 700 kg/h, about 700 kg/h to about 800 kg/h, about 800 kg/h to about 900 kg/h, or about 900 kg/h to about 1000 kg/h. In some additional aspects, the mass flow rate of the hydrogen may be from about 1 kg/h to about 200 kg/h, about 1 kg/h to about 300 kg/h, about 1 kg/h to about 400 kg/h, about 1 kg/h to about 500 kg/h, about 1 kg/h to about 600 kg/h, about 1 kg/h to about 700 kg/h, about 1 kg/h to about 800 kg/h, about 1 kg/h to about 900 kg/h, about 100 kg/h to about 1000 kg/h, about 200 kg/h to about 1000 kg/h, about 300 kg/h to about 1000 kg/h, about 400 kg/h to about 1000 kg/h, about 500 kg/h to about 1000 kg/h, about 600 kg/h to about 1000 kg/h, about 700 kg/h to about 1000 kg/h, or about 800 kg/h to about 1000 kg/h. In still additional aspects, the mass flow rate of the hydrogen may be about 1 kg/h, 10 kg/h, 20 kg/h, 30 kg/h, 40 kg/h, 50 kg/h, 60 kg/h, 70 kg/h, 80 kg/h, 90 kg/h, 100 kg/h, 200 kg/h, 300 kg/h, 400 kg/h, 500 kg/h, 600 kg/h, 700 kg/h, 800 kg/h, 900 kg/h, or about 1000 kg/h. In a non-limiting example, the mass flow rate of hydrogen is about 55-75 kg/h, about 60-65 kg/h, about 62-64 kg/h, or about 63 kg/h.

The volumetric flow rate of the hydrogen from the hydrogen generator 202 may be from about 10 Nm³/h to about 12000 Nm³/h. In some aspects, the volumetric flow rate of the hydrogen may be about 10 Nm³/h to about 100 Nm³/h, about 100 Nm³/h to about 1000 Nm³/h, about 1000 Nm³/h to about 2000 Nm³/h, about 2000 Nm³/h to about 3000 Nm³/h, about 3000 Nm³/h to about 4000 Nm³/h, about 4000 Nm³/h to about 5000 Nm³/h, about 5000 Nm³/h to about 6000 Nm³/h, about 600 Nm³/h to about 7000 Nm³/h, about 7000 Nm³/h to about 8000 Nm³/h, about 8000 Nm³/h to about 9000 Nm³/h, about 9000 Nm³/h to about 10000 Nm³/h, about 10000 Nm³/h to about 11000 Nm³/h, or about 11000 Nm³/h to about 12000 Nm³/h. In some additional aspects, the volumetric flow rate of the hydrogen may be about 10 Nm³/h to about 1000 Nm³/h, 10 Nm³/h to about 2000 Nm³/h, about 10 Nm³/h to about 3000 Nm³/h, about 10 Nm³/h to about 4000 Nm³/h, about 10 Nm³/h to about 5000 Nm³/h, about 10 Nm³/h to about 6000 Nm³/h, about 10 Nm³/h to about 7000 Nm³/h, about 10 Nm³/h to about 8000 Nm³/h, about 10 Nm³/h to about 9000 Nm³/h, about 10 Nm³/h to about 10000 Nm³/h, about 10 Nm³/h to about 11000 Nm³/h, about 100 Nm³/h to about 12000 Nm³/h, about 2000 Nm³/h to about 12000 Nm³/h, about 3000 Nm³/h to about 12000 Nm³/h, about 4000 Nm³/h to about 12000 Nm³/h, about 5000 Nm³/h to about 12000 Nm³/h, about 6000 Nm³/h to about 12000 Nm³/h, about 7000 Nm³/h to about 12000 Nm³/h, about 8000 Nm³/h to about 12000 Nm³/h, about 9000 Nm³/h to about 12000 Nm³/h, or about 10000 Nm³/h to about 12000 Nm³/h. In still further aspects, the volumetric flow rate is about 10 Nm³/h, 20 Nm³/h, 30 Nm³/h, 40 Nm³/h, 50 Nm³/h, 60 Nm³/h, 70 Nm³/h, 80 Nm³/h, 90 Nm³/h, 100 Nm³/h, 200 Nm³/h, 300 Nm³/h, 400 Nm³/h, 500 Nm³/h, 600 Nm³/h, 700 Nm³/h, 800 Nm³/h, 900 Nm³/h, 1000 Nm³/h, 2000 Nm³/h, 3000 Nm³/h, 4000 Nm³/h, 5000 Nm³/h, 6000 Nm³/h, 7000 Nm³/h, 8000 Nm³/h, 9000 Nm³/h, 10000 Nm³/h, 11000 Nm³/h, or about 12000 Nm³/h. In a non-limiting example, the volumetric flow rate of hydrogen is about 675-725 Nm³/h, about 690-715 Nm³/h, about 700-705 Nm³/h, or about 703.5 Nm³/h.

The hydrogen from the hydrogen generator 202 is then directed to the burner 204. The burner 204 may be any burner suitable for the combustion of hydrogen. The burner may include instrumentation, ductwork, blowers, etc. necessary to direct the flow of the exhaust produced by the combustion of the hydrogen to the drying chamber 210. The burner 204 may be a catalytic combustion burner. Without wishing to be bound by theory, catalytic combustion burners generate fewer NOₓ emissions as compared to other burners and are thus favored to reduce the amount of pollutants generated. The catalyst may include platinum, palladium, rhodium, zirconium, cerium, or other catalysts known in the art. In some aspects, the catalyst may be coated on a ceramic core. In some embodiments, the combustion exhaust may include hydrogen, oxygen, water, and nitrogen. In a non-limiting example, the combustion exhaust consists essentially of hydrogen, oxygen, water, and nitrogen. In some embodiments, the burner may comprise a plurality of burners connected in parallel or a single burner. In some embodiments, the burner may be modified with one or more NOₓ reduction systems.

The combustion exhaust may comprise at least 99% hydrogen, oxygen, water, and nitrogen; for example, the combustion exhaust may comprise at least 99%, 99.5%, 99.9%, 99.99%, or 99.999% hydrogen, oxygen, water, and nitrogen. The combustion exhaust may comprise less than 1% pollutants; for example, the combustion exhaust may comprise less than 1%, less than 0.5%, less than 0.1%, less than 0.01%, or less than 0.001% pollutants.

The first blower 206 may provide oxygen to the burner 204. In some embodiments, the oxygen may be provided as air. The first blower 206 may be any blower, fan, or other gas-mover known in the art. In some additional embodiments, the oxygen may be provided as pure or high-concentration oxygen. Without wishing to be bound by theory, providing pure or high-concentration oxygen to the burner may reduce the formation of NO gas in the combustion exhaust. In some embodiments, the oxygen may be generated off-site.

The system may include an oxygen generator to provide oxygen to the burner 204. In some aspects, the oxygen generator may be an electrolyzer. In some exemplary embodiments, the oxygen generator and the hydrogen generator are the same electrolyzer. In some embodiments, the burner may produce little or no particulate matter, NON, SON, carbon monoxide, or carbon dioxide. The burner may further comprise a blower to provide the combustion exhaust to the drying chamber or, in other embodiments, to a heat exchanger.

The combustion exhaust is then directed from the burner 204 to the drying chamber 210. The material to be dried is fed to the drying chamber 210. As the combustion exhaust contacts the material to be dried, water from the material begins to vaporize. The combustion exhaust and the water vapor exit the drying chamber 210 as humid air, and the dried product exits the drying chamber 210 for further processing.

A second blower 208 may be included for temperature trimming the combustion exhaust. The second blower 208 may be any blower, fan, or other gas-mover known in the art. The second blower 208 provides cool air to the combustion exhaust exiting the burner 204 prior before the combustion exhaust enters the drying chamber 210. This allows the temperature of the combustion exhaust entering the drying chamber 210 to be controlled by providing an amount of air that is cooler than the combustion exhaust, and thus a constant temperature in the drying chamber may be maintained.

The drying chamber 210 may be an industrial oven or an industrial dryer. Industrial ovens and industrial dryers and methods of making the same are well-known by those having ordinary skill in the art. In some embodiments, the drying chamber is electric and is preferably powered by a renewable energy source such as solar, wind, hydroelectric, geothermal, hydrogen fuel cells, etc. In an example, the drying chamber is electric and is powered by hydrogen fuel cells. In some embodiments, the system may include a plurality of drying chambers.

The temperature of the drying chamber 210 may be from about 30° C. to about 150° C. The temperature of the drying chamber may be the same as the temperature of the combustion exhaust. Alternatively, the temperature of the drying chamber may be different from the temperature of the combustion exhaust. For example, the temperature of the drying chamber may be adjusted by introducing cool air into the drying chamber or mixing the combustion exhaust with cool air before entering the drying chamber.

In some aspects, the temperature of the drying chamber 210 may be from about 30° C. to about 40° C., about 40° C. to about 50° C., about 50° C. to about 60° C., about 60° C. to about 70° C., about 70° C. to about 80° C., about 80° C. to about 90° C., about 90° C. to about 100° C., about 100° C. to about 110° C., about 110° C. to about 120° C., about 120° C. to about 130° C., about 130° C. to about 140° C., or about 140° C. to about 150° C. In some additional aspects, the temperature of the drying chamber may be from about 30° C. to about 50° C., about 30° C. to about 60° C., about 30° C. to about 70° C., about 30° C. to about 80° C., about 30° C. to about 90° C., about 30° C. to about 100° C., about 30° C. to about 110° C., about 30° C. to about 120° C., about 30° C. to about 130° C., about 30° C. to about 140° C., about 30° C. to about 150° C., about 40° C. to about 150° C., about 50° C. to about 150° C., about 60° C. to about 150° C., about 70° C. to about 150° C., about 80° C. to about 150° C., about 90° C. to about 150° C., about 100° C. to about 150° C., about 110° C. to about 150° C., about 120° C. to about 150° C., or about 130° C. to about 150° C. In still additional aspects, the temperature of the drying chamber may be about 30° C., 40° C., 50° C., 60° C., 70° C., 80° C., 90° C., 100° C., 110° C., 120° C., 130° C., 140° C., or about 150° C.

The system 200 may include a condenser to capture the humid air exiting the drying chamber 210. The water from the humid air may be condensed by any condenser known to those having skill in the art. In some aspects, the condenser may also be in fluid communication with the air from the first blower 206 or the second blower 208 to provide heat to the air. In some embodiments, the condensed water from the humid air may be used in an electrolyzer, thereby reducing the need to collect water from lakes, rivers, or other natural sources. In other embodiments, the condensed water from the humid air may be used as irrigation water. In still other embodiments, the water from the humid air may be condensed for use in another process.

In some embodiments, the condenser may be used to heat air entering the burner 204 or entering the drying chamber 210.

Waste heat from the system may be captured via a thermal loop (also referred to as a “coolant loop”). Methods for capturing waste heat are generally known by those skilled in the art and generally include heat exchangers. The waste heat may be directed to the drying chamber or may be directed to another process. In an exemplary embodiment, the waste heat is captured and used for processing plant waste to create fertilizer, thus reducing the environmental impact on local soil and water sources. A thermal loop comprising a circulating heat exchange fluid may be used to capture and direct waste heat where it is needed. The thermal loop includes one or more pumps, valves, and/or heat exchangers necessary to capture waste heat in the and deliver heat to other unit operations. The heat exchange fluid (also referred to herein as a “coolant”) may comprise water, glycol (e.g., ethylene glycol), and combinations thereof as well as other heat exchange fluids known in the art.

The systems of the present disclosure may further comprise a hydrogen storage system. Systems and methods for storing hydrogen are generally well-known in the art and include, for example, storage tanks and vessels. Such hydrogen storage systems may be used to store hydrogen for use when the hydrogen generator is not functioning, thereby providing a continuous flow of hydrogen to the burner. The hydrogen generator may be in fluid communication with the hydrogen storage system to provide hydrogen to the hydrogen storage system. The hydrogen storage system may also be in fluid communication with the burner to provide hydrogen to the burner. The hydrogen storage system may comprise pressurized hydrogen. The pressurized hydrogen may be stored at a pressure from about 10 bar to about 800 bar; for example, about 10 bar, about 50 bar, about 100 bar, about 150 bar, about 200 bar, about 250 bar, about 300 bar, about 350 bar, 400 bar, 450 bar, 500 bar, 550 bar, 600 bar, 650 bar, about 700 bar, about 750 bar, or about 800 bar. The pressurized hydrogen may be stored at a pressure from about 10 bar to about 50 bar, about 10 bar to about 100 bar, about 10 bar to about 200 bar, about 10 bar to about 300 bar, about 10 bar to about 400 bar, about 10 bar to about 500 bar, about 10 bar to about 600 bar, about 10 bar to about 700 bar, about 10 bar to about 800 bar, about 100 bar to about 800 bar, about 200 bar to about 800 bar, about 300 bar to about 800 bar, about 400 bar to about 800 bar, about 500 bar to about 800 bar, about 600 bar to about 800 bar, about 700 bar to about 800 bar, about 300 bar to about 700 bar, or about 300 bar to about 600 bar. In some examples, the hydrogen may be stored at a pressure of about 350 bar, about 550 bar, or about 700 bar. One or more hydrogen pumps, including electrochemical hydrogen pumps, may be used to pressurize the hydrogen. Alternatively, other devices and systems to increase the pressure of the hydrogen may be used, such as a compressor.

The systems of the present disclosure may further comprise a dryer for removing water from the hydrogen gas prior to the combustion of the hydrogen gas. The dryer may be, for example, a pressure swing adsorption (PSA) system, a temperature swing adsorption (TSA) system, a hybrid PSA-TSA system, or a membrane purifier. The dryer may comprise an inlet portion and an outlet portion. The dryer may include one or more beds of a water-adsorbent material, such as activated carbon, silica, zeolite, alumina, or a combination thereof. The dryer may include a membrane such as a PEM electrolyte. The inlet portion of the dryer is operable to receive hydrogen gas from the hydrogen generator. The inlet portion may therefore be in fluid communication with the hydrogen generator. The hydrogen gas produced by the hydrogen generator may have a purity from about 95% to about 98%, wherein the major impurity is water. The outlet portion of the dryer is operable to provide dry hydrogen to the burner, to a hydrogen storage system, and/or to a hydrogen fuel cell. The outlet portion may therefore be in fluid communication with the burner, the hydrogen storage system, and/or to the hydrogen fuel cell. The dryer may also comprise a second outlet comprising low pressure hydrogen, e.g., from about 1 to about 2 bar, or less than about 1 bar.

The system may further comprise an electricity storage system. The electricity storage system may include any system known in the art for storing electricity, such as batteries. The electricity storage system may be in electrical communication to the electrolyzer to provide power to the electrolyzer when power from another source is unavailable. Preferably, the electricity storage system receives electricity for storage from a renewable energy source, such as solar, wind, hydroelectric, geothermal, or a hydrogen fuel cell.

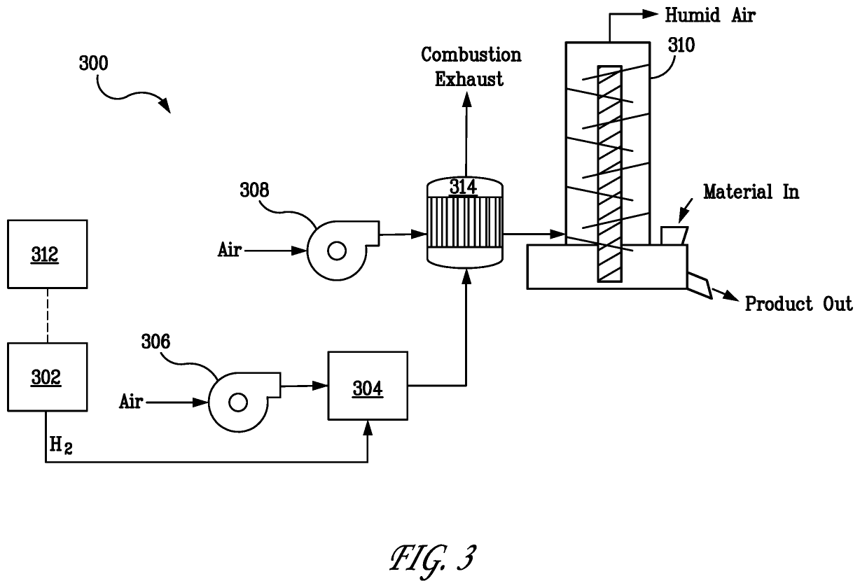

Referring now to FIG. 3, a system of the present disclosure 300 includes a hydrogen generator 302, a burner 304, a first blower 306, a second blower 308, a drying chamber 310, and a heat exchanger 314. Combustion exhaust from the burner 304 is directed to the heat exchanger. The second blower 308 blows cool air into the heat exchanger 314, which is warmed by the combustion gas from the burner 304 before entering the drying chamber 310. The combustion gas then exits the heat exchanger 314 and is either released to the atmosphere or is directed to another part of the plant for further processing. In some embodiments, the system may include a renewable energy source 312 to provide electricity to the facility.

The heat exchanger 314 may be any heat exchanger known to those having ordinary skill in the art. In some embodiments, the heat exchanger may be a shell and tube heat exchanger, a double tube heat exchanger, or a tube in tube heat exchanger.

Excess water in the combustion exhaust exiting the heat exchanger 314 may be captured. In some embodiments, the water in the combustion exhaust may be captured using a condenser. In some embodiments, the condensed water from the combustion exhaust may be used in an electrolyzer. In other embodiments, the condensed water from the combustion exhaust may be used as irrigation water. In still other embodiments, the water from the combustion exhaust may be condensed for use in another process.

The system of the present disclosure generates fewer greenhouse gas emissions compared to a system using gas, oil, coal, timber, or biomass. In some embodiments, the system generates at least about 90% fewer greenhouse gas emissions as compared to a system that uses gas, oil, coal, biomass, or timber as a fuel source.

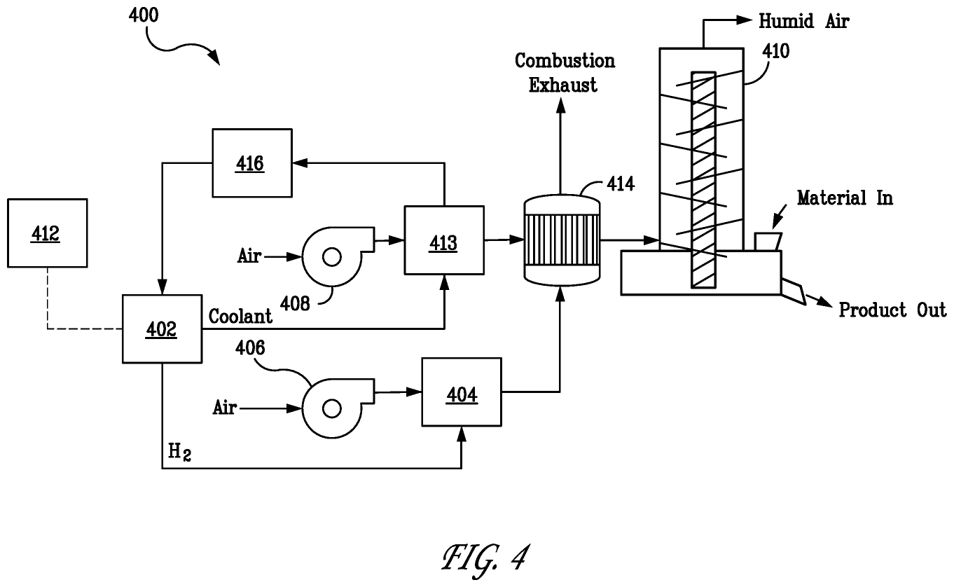

Referring now to FIG. 4, a system of the present disclosure 400 includes a hydrogen generator 402, a burner 404, a first blower 406, a second blower 408, a drying chamber 410, a first heat exchanger 413, a second heat exchanger 414, and a radiator 416. Combustion exhaust from the burner 404 is directed to the heat exchanger. The second blower 408 blows cool air into the first heat exchanger 413. The cool air is warmed by waste heat produced by the hydrogen generator 402. The waste heat produced by the hydrogen generator 402 is then directed to a radiator 416 to be released to the atmosphere. After being warmed by the first heat exchanger 413, the warmed air flows into the second heat exchanger 414, where the air is warmed further by the heat from the combustion gas from the burner 404 before entering the drying chamber 410. The combustion gas then exits the second heat exchanger 414 and is either released to the atmosphere or is directed to another part of the plant for further processing. In some embodiments, the system may include a renewable energy source 412 to provide electricity to the facility. This embodiment therefore provides further efficiency gains by adding additional warming to the air before the air enters the drying chamber 410.

The first heat exchanger 413 and the radiator 416 may be in fluid communication with the hydrogen generator 402 via a thermal loop (also referred to as a “coolant loop”). The thermal loop comprises a heat exchange fluid to transfer heat energy produced by the operation of the hydrogen generator 402 to the first heat exchanger 413. The first heat exchanger then provides heat to cool air being blown by the second blower 408 into the drying chamber 410. The heat exchange fluid is then directed to the radiator 416 to release the remaining heat energy to the atmosphere before returning to the hydrogen generator 402 to continue the cycle. The heat exchange fluid may be any heat exchange fluid known in the art, such as water, glycol (e.g., ethylene glycol), or combinations thereof. It should be understood that a thermal loop may be incorporated into any of the systems described herein.

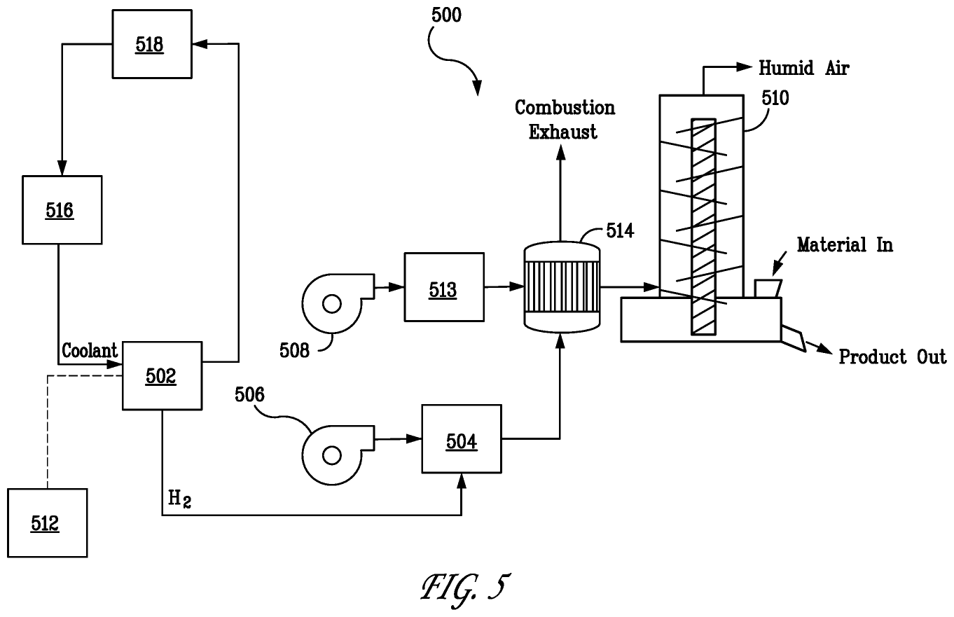

Referring now to FIG. 5, a system of the present disclosure 500 includes a hydrogen generator 502, a burner 504, a first blower 506, a second blower 508, a drying chamber 510, a first heat exchanger 513, a second heat exchanger 514, a radiator 516, and a fertilizer processing plant 518. Combustion exhaust from the burner 504 is directed to the heat exchanger. The second blower 508 blows cool air into the first heat exchanger 513. The cool air is warmed by waste heat produced by the hydrogen generator 502. The waste heat produced by the hydrogen generator 502 is then directed to a radiator 516 to be released to the atmosphere. After being warmed by the first heat exchanger 513, the warmed air flows into the second heat exchanger 514, where the air is warmed further by the heat from the combustion gas from the burner 504 before entering the drying chamber 510. The combustion gas then exits the second heat exchanger 514 and is either released to the atmosphere or is directed to another part of the plant for further processing. In some embodiments, the system may include a renewable energy source 512 to provide electricity to the facility.

The fertilizer processing plant 518 is operable to receive waste heat generated by the functioning of the hydrogen generator 502 via a thermal loop. The thermal loop comprises a heat exchange fluid to transfer heat energy produced by the operation of the hydrogen generator 502 to the fertilizer processing plant 518. The heat exchange fluid is then directed to a radiator 516 to release additional waste heat to the atmosphere prior to returning to the hydrogen generator 502 to continue the cycle. The heat exchange fluid may be any heat exchange fluid described herein.

Those having skill in the art will appreciate that the second blower 508, the first heat exchanger 513, and the second heat exchanger 514 may be removed, and the combustion exhaust may be directly supplied to the drying chamber 510.

In some embodiments, the system may have increased reliability compared to a system using gas, oil, coal, timber, or biomass. Having multiple sources of hydrogen improves redundancy of the system, and thus reliability. Reliability may also be improved by adding a renewable energy source to the system, which may reduce reliance on a municipal or regional power grid. In addition to burning hydrogen, the burner may additionally combust another fuel source such as coal, natural gas (including liquid petroleum gas and pressurized natural gas), biomass, a combination thereof, etc. Although this increases the number of greenhouse gas emissions produced by the system, there is increased reliability from having multiple sources of fuel capable of providing heat to the drying chamber.

In some embodiments, the system may include N+1 redundancy, wherein the system includes N+1 hydrogen generators and N is the number of hydrogen generators required to meet the demands of the system. In some embodiments, the system may include N+N redundancy, wherein if a hydrogen generator fails, one or more additional hydrogen generators will be able to provide the hydrogen required by the system.

### II. Methods

Further described herein are methods for drying a material using hydrogen combustion exhaust. The method may be accomplished using any of the systems described in Section I above. The method includes burning hydrogen to create combustion exhaust and contacting the combustion exhaust with the material. The hydrogen may be burned via catalytic combustion or any other burner known in the art.

The method may further include generating hydrogen. The hydrogen may be generated using a hydrogen generator as described in Section I. In some aspects, the hydrogen may be generated by a electrolyzer. In some additional aspects, the hydrogen may be generated using a reformer-based generator, such as a steam methane reformer. In an exemplary embodiment, the hydrogen is generated in a PEM electrolyzer. In some aspects, heat produced by generating the hydrogen may be provided to a heat load (i.e., a system or device requiring heat) via a coolant loop. The heat load may include, for example, a fertilizer processing plant.

The method may further comprise cooling the combustion exhaust before the combustion exhaust contacts the material. In some embodiments, the cooling may be accomplished by mixing the combustion exhaust with cool air. The air may be introduced via a blower as described in Section I.

The method may further include generating oxygen. The oxygen may be generated using any oxygen generator described in Section I above. In some embodiments, the oxygen may be generated using an electrolyzer. In an exemplary embodiment, the hydrogen generator and the oxygen generator are the same electrolyzer.

The method may further include condensing the water in the combustion exhaust after contacting the combustion exhaust with the material. The condensing may be accomplished by using a condenser. In some aspects, the method may further include recycling the condensed water to the hydrogen generator. In some additional aspects, the method may include using the condensed water as irrigation water.

In an alternative embodiment, the method may comprise using the combustion exhaust to heat the air via a heat exchanger, such as in the system shown in FIG. 3. The method may also comprise pre-heating the cool air prior heating by the combustion exhaust. The pre-heating may comprise transferring heat from the hydrogen generator via a coolant loop, which then transfers heat to the cool air via a second heat exchanger, as in the system shown in FIG. 4.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Thus, references to one or an embodiment in the present disclosure may be references to the same embodiment or any embodiment; and such references mean at least one of the embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the terms “a,” “an,” and “the” are understood to encompass the plural as well as the singular. Thus, the term “a mixture thereof” also relates to “mixtures thereof” and the term “a component” also refers to “components.”

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/m L” should also be understood to provide support for the range of “50 mg/mL to 80 mg/mL.”

The terms “comprising”, “including” and “having” are intended to be inclusive and mean that there may be additional elements other than the listed elements.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

### EXAMPLES

### Example 1: Coffee Bean Drying

In an exemplary embodiment, the systems and methods of the present disclosure may be used to dry coffee beans.

The system for drying coffee beans is operable to dry 25 MT of coffee beans per day. The system produces hydrogen using an electrolyzer at a rate of 63 kg/hr. The electrolyzer consumes approximately 7095 m³ of water per year. The water for the electrolyzer is supplied from a river or natural spring near the drying facility. Tap water is also available for use in the electrolyzer.

Each batch of coffee beans is dried in the drying chamber for about 20 hours at about 40° C. Coffee beans entering the drying chamber have a water content of about 35% and coffee beans exiting the drying chamber have a water content of about 10.5%. The drying chamber includes about 14 drying tumbles. Each tumble has a diameter of about 1 m and a length of about 5 m. Each drying tumble spins at a rate of about 1 revolution per minute. Each drying tumble has a capacity of about 2.5-4 MT of coffee beans per batch.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present systems and methods, which, as a matter of language, might be said to fall therebetween.

What is claimed is:

1. A system for drying a material by using hydrogen combustion exhaust, the system comprising:
a hydrogen generator;
a burner in fluid communication with the hydrogen generator; and
a drying chamber in fluid communication with the burner operable to receive the material and combustion exhaust generated in the burner,
wherein the combustion exhaust directly contacts the material.

2. The system of claim 1, wherein the material includes an agricultural product.

3. The system of claim 2, wherein the agricultural product is selected from the group consisting of coffee beans, cocoa, wheat, corn, barley, millet, sorghum, oats, rice, rye, legumes, chia, quinoa, buckwheat, mustard, rapeseed, sunflower seed, flax seed, poppy seed, and tea.

4. The system of claim 3, wherein the agricultural product includes coffee beans.

5. The system of claim 1, wherein the hydrogen generator is an electrolyzer.

6. The system of claim 5, wherein the electrolyzer is a proton exchange member based electrolyzer.

7. The system of claim 1, wherein the hydrogen generator is a steam methane reformer.

8. The system of claim 1, wherein the hydrogen generator is located at the same site as the drying chamber.

9. The system of claim 1, wherein the burner is a catalytic combustion burner.

10. The system of claim 1, further comprising a first blower operable to provide an oxygen source to the burner.

11. The system of claim 10, wherein the oxygen source comprises air.

12. The system of claim 10, wherein the oxygen source comprises pure oxygen.

13. The system of claim 1, further comprising a second blower operable to provide cool air to the combustion exhaust.

14. The system of claim 1, further comprising a condenser in fluid communication with the drying chamber.

15. The system of claim 1, further comprising a renewable energy source.

16. The system of claim 15, wherein the renewable energy source includes photovoltaic power, wind power, hydroelectric power, a hydrogen fuel cell, or combinations thereof.

17. The system of claim 1, wherein the drying chamber is an industrial dryer.

18. The system of claim 1, wherein the drying chamber is an industrial oven.

19. The system of claim 1, wherein the combustion exhaust consists essentially of water, hydrogen, oxygen, and nitrogen.

20. A system for drying a material by using hydrogen combustion exhaust, the system comprising:
a hydrogen generator;
a burner in fluid communication with the hydrogen generator;
a heat exchanger in fluid communication with the burner and the drying chamber; and
a drying chamber in fluid communication with the burner operable to receive the material and combustion exhaust generated in the burner,
wherein the combustion exhaust consists essentially of water, hydrogen, oxygen, and nitrogen.

21. A method for drying a material using hydrogen combustion exhaust, the method comprising:
burning hydrogen to create combustion exhaust; and
contacting the material with the combustion exhaust.
